(19) United States
(12) Patent Application Publication
(10) Pub. No.: US 2026/0299297 A1
(43) Pub. Date: Oct. 1, 2026

(54) OPTICAL MODULE AND HEAD-MOUNTED DISPLAY DEVICE

(71) Applicant: Goertek Optical Technology Co., Ltd., Shandong (CN)

(72) Inventor: Yudeng Wu, Shandong (CN)

(73) Assignee: Goertek Optical Technology Co., Ltd., Shandong (CN)

(21) Appl. No.: 18/998,186

(22) PCT Filed: Jul. 10, 2023
(86) PCT No.: PCT/CN2023/106458

§ 371 Date: Jan. 24, 2025

(30) Foreign Application Priority Data
Jul. 26, 2022 (CN) 202210890139.2

(51) Int. Cl. G02B 27/01

(52) U.S. Cl. CPC G02B 27/0172

(57) ABSTRACT

The disclosure provides an optical module and a head mounted display. The optical module includes: a display screen with a size of D1, having a light-emitting side; a lens group located on a the light-emitting side of the display screen; the lens group includes at least one lens; wherein the optical module further includes a polarizing element, a beam splitting element and a phase retarder, wherein the polarizing element has an effective diameter of B1; the polarizing element, the beam splitting element, and the phase retarder are provided on either side of a lens in the lens group; a distance from the polarizing element to the display screen is L1, which satisfies: −0.2<B1/2−D1/2/L1<0.8.

### CROSS-REFERENCE TO RELATED APPLICATIONS

The present disclosure is a National Stage of International Application No. PCT/CN2023/106458, filed on Jul. 10, 2023, which claims priority to a Chinese patent application No. 202210890139.2 filed with the CNIPA on Jul. 26, 2022 and entitled “OPTICAL MODULE AND HEAD MOUNTED DISPLAY”, both of which are hereby incorporated by reference in their entireties.

### TECHNICAL FIELD

Embodiments of the present disclosure relate to the technical field of near-eye display imaging, and particularly to an optical module and a head mounted display.

### BACKGROUND

In recent years, Augmented Reality (AR) and Virtual Reality (VR) technologies have found applications in devices such as smart wearable devices and experienced rapid development. Both AR and VR technologies rely on optical modules as their core components. The quality of image display produced by the optical modules directly determines the quality of a smart wearable device.

In current VR design solutions, screens such as LCDs and OLEDs are predominantly used. Such screens commonly exhibit the issue where image brightness varies with changes in viewing angle; specifically, image brightness decreases as the viewing angle increases.

When such screens are used in VR optical modules, when the user observes an image at different viewing angles, due to the difference in the angle of incident light at different viewing angles, the brightness of the screen itself changes with the change in the viewing angle, and the brightness of the image changes with the brightness of the screen itself, resulting in a significant contrast in the relative brightness of the image.

### SUMMARY

An objective of the present disclosure is to provide new technical solutions for an optical module and a head mounted display.

According to a first aspect, the present disclosure provides an optical module, which includes:
a display screen with a size of D1;
a lens group located on a light-emitting side of the display screen; the lens group includes at least one lens;
wherein the optical module further includes a polarizing element, a beam splitting element and a phase retarder, wherein the polarizing element has an effective diameter of B1; the polarizing element, the beam splitting element, and the phase retarder are provided on either side of a lens in the lens group;
a distance from the polarizing element to the display screen is L1;
wherein the optical module satisfies: −0.2<B1/2−D1/2/L1<0.8.

Optionally, the optical module satisfies: −0.05<B1/2−D1/2/L1<0.8.

Optionally, the optical module satisfies: 7.5<β<19, wherein β is a field-of-view magnification.

Optionally, the lens group includes a lens adjacent to the display screen, the lens has a surface facing towards the display screen, and the beam splitting element is located on one side of the surface.

Optionally, the polarizing element is provided on a side of the lens group facing away from the display screen; or
the lens group includes at least two lenses, which include a first lens closest to an eye side, wherein the first lens has a surface facing away from a human eye, and the polarizing element is located on one side of the surface.

Optionally, the phase retarder includes a first phase retarder, which is provided on a side of the lens group facing away from the display screen, and is provided closer to the display screen than the polarizing element;
the lens group includes at least two lenses, which include a first lens closest to an eye side, wherein the first lens has a surface facing away from a human eye, and the first phase retarder is located on one side of the surface and is provided farther away from the first lens than the polarizing element.

Optionally, the phase retarder further includes a second phase retarder, the lens group includes a lens adjacent to the display screen, the lens has a surface facing towards the display screen, and the second phase retarder is located on one side of the surface and is provided closer to the display screen than the beam splitting element.

Optionally, the lens group includes a lens adjacent to the display screen, and the lens has a positive optical power.

Optionally, the distance from the polarizing element to the display screen satisfies: 10 mm<L1<35 mm.

Optionally, the effective diameter of the polarizing element satisfies: 30 mm<B1<55 mm.

Optionally, the optical module has a field of view of 80°≤FOV≤120°.

Optionally, the optical module has an effective focal length of 14 mm<F<38.5 mm.

In a second aspect, a head mounted display is proposed. The head mounted display includes:
a housing; and
the optical module according to the first aspect.

According to the embodiment of the present disclosure, by limiting the ratio between the difference in the effective diameter of the polarizing element provided in the optical module and the size of the display screen, relative to the distance from the polarizing element to the display screen, it is possible to minimize the variation in relative image brightness when the user observes the image at different viewing angles. This enhances the visual viewing experience of the user.

Other features and advantages of the present disclosure will become apparent from the following detailed description of exemplary embodiments of the present disclosure with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 shows a first structural schematic diagram of an optical module provided in an embodiment of the present disclosure.

FIG. 2 shows a second structural schematic diagram of the optical module provided in an embodiment of the present disclosure.

FIG. 3 shows a third structural schematic diagram of the optical module provided in an embodiment of the present disclosure.

### DESCRIPTION OF REFERENCE SIGNS

1. display screen; 2. lens group; 21. first lens; 22. second lens; 23. third lens; 3. polarizing element; 4. stop; 5. beam splitting element; 6. first phase retarder.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

In the prior art, aiming at the problem that the brightness of the display screen changes with the change of the user's viewing angle, at present, it is mainly through the software to adjust the brightness of a localized area of the display screen, or to improve the internal structure of the display screen, so as to meet the requirement on appropriate relative brightness. However, the existing method increases the energy consumption and design cost of the system.

In view of the above technical problems, the first aspect of the embodiments of the present disclosure provides an optical module. The optical module is a folded optical path optical structure design, which may include at least one optical lens and be suitable for use in the head mounted display (HMD), such as VR headsets, which may include products like VR glasses or VR helmets, without any specific limitation in the embodiments of the present disclosure.

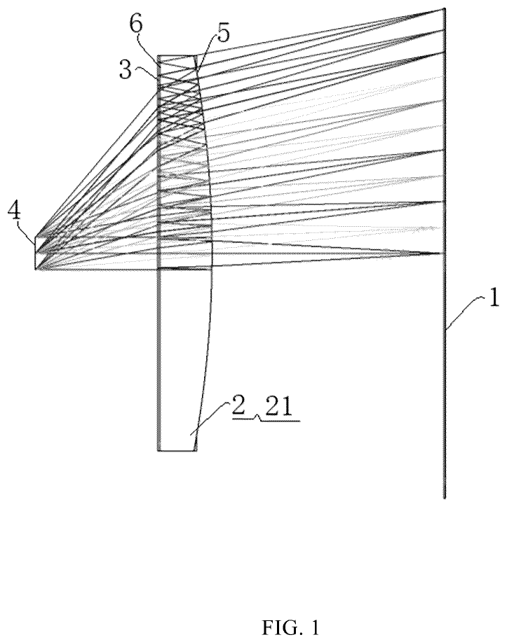

The optical module and the head mounted display provided by the embodiments of the present disclosure are described in detail below with reference to FIGS. 1 to 3.

The embodiment of the present disclosure provides an optical module. As shown in FIGS. 1 to 3, the optical module comprises: a display screen 1, a lens group 2, a polarizing element 3, a beam splitting element 5, and a phase retarder.

The display screen 1 has a size of D1. The lens group 2 includes at least one lens. The optical module also includes a polarizing element 3 with an effective diameter of B1, a beam splitting element 5, and a phase retarder. The distance from the polarizing element 3 to the display screen 1 is L1. Here, the optical module satisfies: −0.2<(B1/2−D1/2)/L1<0.8.

In other words, the optical module mainly consists of the display screen 1, the lens group 2, the polarizing element 3, the beam splitting element 5, and the phase retarder.

Here, the display screen 1 can be an LCD display screen, or an OLED display screen. Even though the image brightness of the display screen 1 changes with the viewing angle of the user, the present disclosure controls and limits the relationship between the effective diameter B1 of the polarizing element 3, the size D1 of the display screen 1, and the distance L1 from the polarizing element 3 to the display screen 1, such that after displaying the image, the difference in display brightness between the central area and the edge area of the display screen 1 is relatively small, thereby enhancing the display effect.

Here, the lens group 2 includes at least one lens. For example, referring to FIGS. 1 to 3, the lens group 2 may include one lens, two lenses, or three lenses, etc. By using an optical architecture with one lens, two lenses, or three lenses, the optical path folded design is achieved. In the present embodiment, regardless of how the optical architecture of the lens group 2 is designed, meaning regardless of how light is folded and propagates within the folded optical path, the lens closest to the human eye transmits light into the eye so that the light can enter the human eye for displaying the image. In this way, the human eye can see the complete image. In the present embodiment, as long as the parameter relationships limited by the embodiment of the present disclosure are met, the difference in display brightness between the central area and the edge areas of the display screen 1 can be reduced, and the human eye visually observes that the brightness difference of the image is small, thereby obtaining a better experience effect.

Here, for implementing the folded optical path design, the polarizing element 3, the beam splitting element 5, and the phase retarder are provided within the optical module. For example, the polarizing element 3, the beam splitting element 5, and the phase retarder are provided on either side of the lens of the lens group 2.

Specifically, for implementing the folded optical path design, the polarizing element 3, the beam splitting element 5, and the phase retarder are provided on either side of the lens of the lens group 2. For example, the beam splitting element 5 is provided on the side of the lens group 2 facing towards the display screen 1; the polarizing element 3 is provided on the side of the lens group 2 facing away from the display screen 1, or on a side of one lens in the lens group 2; the phase retarder is provided on the side of the lens group 2 facing towards the display screen 1, or on a side of one lens in the lens group 2.

Here, the polarizing element 3 can be used to transmit P-polarized light and reflect S-polarized light; or the polarizing reflection element can be used to transmit S-polarized light and reflect P-polarized light. Specifically, the polarizing element 3 has a polarization transmission direction, and light can pass through the polarizing element 3 smoothly only when it vibrates along the polarization transmission direction, while light vibrating in other directions is reflected when it encounters the polarizing element 3. For example, the polarizing element 3 can be a polarizing reflection film, a reflective polarizer or the like. Regardless of where the polarizing element 3 is located, the present embodiment limits the distance L1 from the polarizing element 3 to the display screen 1 and the effective diameter B1 of the polarizing element 3.

Here, the phase retarder may be used to change the polarization state of light in the folded optical path structure, such as converting linearly polarized light into circularly polarized light or vice versa. For example, the phase retarder can be a quarter-wave plate.

Here, when the light passes through the beam splitting element 5, part of the light is transmitted and the other part is reflected, which does not consider the absorption of the light. For example, light propagating from the display screen 1 to the eye side may transmit through the beam splitting element 5, while light propagating from the eye side to the display screen 1 is reflected by the beam splitting element 5. The beam splitting element 5 may be a transflective film or a polarizing film.

In the present embodiment, the size of the display screen 1 is D1, wherein the size of the display screen 1 refers to: the maximum size of the screen used for displaying image frames, such as the maximum size of the area of the display screen 1 for displaying image frames.

In the present embodiment, by limiting (B1/2−D1/2)/L1 within this range, it is possible to adjust the brightness uniformity of the displayed image (the smaller the difference, the higher the uniformity; the larger the difference, the lower the uniformity), so that when the user observes images at different viewing angles, the brightness differences of images at different viewing angles are relatively small. That is, when the user observes images in the central area and edge areas, the brightness differences that is perceived visually is relatively small, making it less likely for user's eyes to become fatigued when observing the screen and thus enhancing user experience.

Specifically, the polarizing element 3 acts as the most critical and effective layer for reflecting light in the folded optical path. The light direction of the image edge region of the display screen 1 reflected by the polarizing element 3 can basically correspond to the light direction of the marginal field of view in the light source module. Specifically, the tangent value of the angle of the edge light is approximately equal to the ratio of the difference between the effective diameter B1 of the polarizing reflective film 3 and the size D1 of the display screen 1, to the distance L1 from the polarizing reflective film 3 to the display screen 1.

Therefore, to better simulate the incident angle of the light emitted from the image in the display screen 1 (since the incident angle cannot be accurately controlled), the present embodiment limits the relationship between three parameters: the effective diameter B1 of the polarizing element 3, the distance L1 from the polarizing element 3 to the display screen 1, and the size D1 of the display screen 1, such that (B1/2−D1/2)/L1 can basically reflect the brightness relationship between the light brightness of the marginal field of view and that of the central field of view.

Specifically, by making (B1/2−D1/2)/L1 within this range, it is possible to enable good coordination effects between the polarizing element 3 and the display screen 1, as well as between the effective diameter of the polarizing element 3 and the display screen 1. Specifically, (B1/2−D1/2)/L1 mainly regulates the brightness of the marginal field of view, such that the drop in brightness of the marginal field of view relative to the central field of view is controlled to be within 30%, thereby meeting the sensitivity of the human eye to observe the brightness of the image.

Compared with improving the internal structure of the display screen 1 in the prior art or adjusting the brightness of the displayed images through software in the prior art, the present disclosure, by controlling the ratio between the difference in the effective diameter of the polarizing element 3 in the optical module and the size D1 of the display screen 1, relative to the distance from the polarizing element 3 to the display screen 1, it is possible to minimize the variation in relative image brightness when the user observes the image at different viewing angles. This enhances the visual viewing experience of the user.

In one embodiment, the optical module satisfies: −0.05< (B1/2−D1/2)/L1<0.8.

In the present embodiment, the range of (B1/2−D1/2)/L1 in the optical module is further narrowed down. Here, the smaller the value of (B1/2−D1/2)/L1, the smaller the difference in image brightness between the central area and the edge area, meaning the uniformity in the image brightness of the central area and edge area is better.

It should be noted that in the embodiment of the present disclosure, skilled persons in the art can flexibly adjust the ratio relationship between the difference of the effective diameter of the polarizing element 3 provided in the optical module and the size D1 of the display screen 1, and the distance from the polarizing element 3 to the display screen 1 according to specific needs, as long as the ratio relationship is controlled within a preset range.

For example, the range of (B1/2−D1/2)/L1 can be 0~0.8.

For another example, the range of (B1/2−D1/2)/L1 can be 0.1~0.5.

For yet another example, the range of (B1/2−D1/2)/L1 can be −0.1~0.1.

Within these various ratio ranges, it is possible to minimize the variation in relative brightness when the user observes the image at different viewing angles, increasing the uniformity of the image brightness.

Of course, in the embodiment of the present disclosure, the ratio relationship between the difference of the effective diameter of the polarizing element 3 provided in the optical module and the size of the display screen 1, and the distance from the polarizing element 3 to the display screen 1 is not limited to the above three examples, which can be flexibly adjusted by skilled persons in the art according to needs, and is not specifically limited by the embodiment of the present disclosure.

In one embodiment, the optical module satisfies: 7.5<β<19, wherein β is the field of view magnification.

Specifically, in VR design schemes, the optical module is applied in VR designs, achieving magnification of the images displayed by the display screen 1. Since different people experience different virtual image distances when using VR products, It is inaccurate to use the ratio of the virtual image size to the screen display size as a measure of the magnification capability of the VR optical module. Moreover, we know that the optical module used in VR designs not only enlarges the displayed image but also enlarges the viewing angle (such as a magnifying glass enlarging an object), and the enlargement of the viewing angle does not change with different usage conditions of the user, so the viewing angle magnification can be used as a parameter to measure the magnification capability of the VR system.

The present embodiment limits the range of the viewing angle magnification (the vertical magnification β) of the optical module, so that the optical module meets the requirements for the viewing angle magnification from small to large sizes of the display screen 1.

Specifically, the viewing angle magnification (the viewing angle magnification of the optical module is related to the magnification of each lens in the lens group 2) is related to parameters such as the effective diameter of the lens, the focal length of the optical module, and the total optical length of the optical module, theoretically determining the performance of the optical module. For example, the larger the effective diameter of the lens, the higher the resolution, and the greater the usable magnification, the smaller the focal length, which can increase the field of view.

The present embodiment limits (B1/2−D1/2)/L1 within this range, and further by limiting the effective diameter of the polarizing element 3, the size of the display screen 1 as well as the distance from the polarizing element 3 to the display screen 1 so as to further limit the viewing angle magnification of the optical module within this range, the present embodiment further provides better resolution under the control of the brightness of the marginal field of view image, and improves the fineness of the displayed image, such that the user has a better immersion experience.

For example, the optical module satisfies: 5<β<15, for another example, the optical module satisfies: 1<β<8, for yet another example, the optical module satisfies: 3<β<12.

Within the above various ratio ranges, on one hand, it is possible to minimize the variation in relative image brightness when the user observes the image at different viewing angles, and on the other hand, it is possible to provide better resolution.

In one embodiment, referring to FIGS. 1 to 3, the beam splitting element 5 is provided between the display screen 1 and the lens group 2.

In the present embodiment, the setting position of the beam splitting element 5 is limited. Here, the beam splitting element 5 is provided on the side of the lens group 2 facing towards the display screen 1.

In a specific embodiment, the lens group 2 includes the lens closest to the display screen, and the lens has a surface facing towards the display screen on which the beam splitting element 5 is provided. For example, the beam splitting element 5 is attached to the surface.

In another specific embodiment, the beam splitting element 5 is provided between the lens group 2 and the display screen 1. For example, a polarizing element for bearing the beam splitting element 5 is provided between the lens group 2 and the display screen 1, and the beam splitting element 5 is provided on the polarizing element.

It should be noted that those skilled in the art can reasonably adjust the setting position of the beam splitting element 5 as required.

In one embodiment, referring to FIGS. 1 to 3, the polarizing element 3 is provided on the side of the lens group 2 facing away from the display screen 1; or

the lens group 2 includes at least two lenses, and the polarizing element 3 is provided between two adjacent lenses.

In the present embodiment, referring to FIG. 1, the lens group 2 includes one lens, wherein one of the lenses is a first lens 21, and the polarizing element 3 may be provided on the surface of the first lens 21 facing away from the display screen 1. Alternatively, the polarizing element 3 may be provided on the side of the first lens 21 facing away from the display screen 1, but not on the surface of the first lens 21: for example, to provide the polarizing element between the first lens 21 and the human eye.

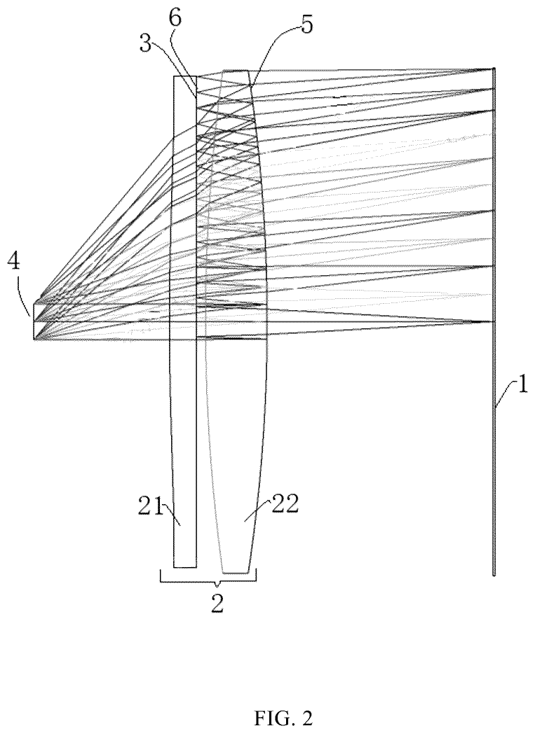

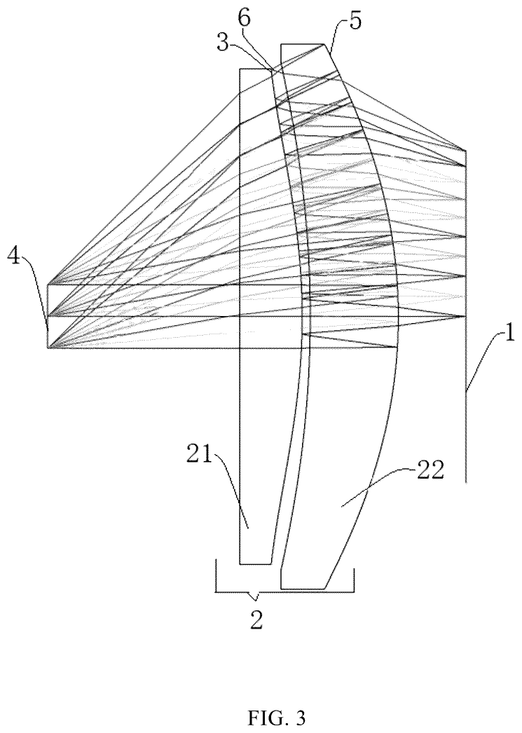

Referring to FIGS. 2 and 3, the lens group 2 includes two lenses including a first lens 21 and a second lens 22, wherein the first lens 21 is provided farther away from the display screen 1 than the second lens 22. The polarizing element 3 is provided on the surface of the first lens 21 facing away from the second lens 22.

It should be noted that those skilled in the art can reasonably adjust the setting position of polarizing element 3 as required.

In one embodiment, the phase retarder includes a first phase retarder 6 provided between the polarizing element and a lens in the lens group, or
the lens group includes at least two lenses, and the first phase retarder 6 is provided between two adjacent lenses.

In the present embodiment, referring to FIG. 1, the first phase retarder 6 is provided on the side of the lens group facing away from the display screen 1, the polarizing element 3 is provided on the side of the lens group 2 facing away from the display screen 1, and the first phase retarder 6 is located between the polarizing element and the lens group. That is, the first phase retarder 6 is located between the first lens 21 and the polarizing element 3. That is, the first phase retarder 6 is provided closer to the display screen 1 than the polarizing element 3.

Referring to FIGS. 2 and 3, the lens group 2 includes two lenses including a first lens 21 and a second lens 22, wherein the first lens 21 is provided farther away from the display screen 1 than the second lens 22. The first phase retarder 6 is provided between the first lens 21 and the second lens 22. For example, the first phase retarder 6 is provided on a surface of the second lens 22 adjacent to the first lens 21; or, the first phase retarder 6 is provided on a surface of the first lens 21 adjacent to the second lens 22; or, the first phase retarder 6 is provided at an appropriate position between the first lens 21 and the second lens 22.

It should be noted that those skilled in the art can reasonably adjust the setting position of the first phase retarder 6 as required.

In one embodiment, the phase retarder further includes a second phase retarder located between the lens group and the display screen.

In the present embodiment, the setting position of the second phase retarder is defined, wherein the second phase retarder is located on the side of the light emitting surface of the display screen, for example, between the lens group and the display screen.

In the present embodiment, the lens group includes a lens provided adjacent to the display screen, and the focal power of the lens is positive.

In the present embodiment, the lens group includes a lens provided adjacent to the display screen, and when the focal power of the lens is positive, the lens is a magnifying lens and magnifies the light emitted from the display screen.

For example, referring to FIGS. 1 to 3, a lens provided adjacent to the display screen includes a first surface provided facing away from the display screen and a second surface provided facing towards the display screen, the first surface being flat or concave and the second surface being convex.

In one embodiment, a distance from the polarizing element 3 to a display screen 1 satisfies: 10 mm<L1<35 mm.

In the present embodiment, in the optical module, wherever the polarizing element 3 is provided in the optical module, it is necessary for the distance from the polarizing element 3 to the display screen 1 to be within this range. The present embodiment controls the distance from the polarizing element 3 to the display screen 1, which, on one hand, makes the range of (B1/2−D1/2)/L1 within the range of −0.2 to 0.8, and reduces the difference between the light brightness of the marginal field of view and the light brightness of the central field of view; on the other hand, by limiting the distance from the polarizing element 3 to the display screen 1, the total optical length of the optical module is limited within a certain range, such that optical module meets the requirement on miniaturization and light weight.

In an optional embodiment, the distance L from the polarizing element 3 to the display screen 1 is: 12 mm≤L1≤20 mm; or the distance L from the polarizing element 3 to the display screen 1 is: 20 mm≤L1≤30 mm.

In one embodiment, the effective diameter of the polarizing element 3 satisfies: 30 mm<B1<55 mm.

In the present embodiment, by limiting the effective diameter of the polarizing element 3, on one hand, it is possible to ensure that the range of (B1/2−D1/2)/L1 falls within −0.2 to 0.8, thereby reducing the difference in light brightness between the marginal field of view and the central field of view; on the other hand, after the polarizing element 3 processes the light, it is possible that the processed light can better simulate the light of the marginal field of view of the optical module, and (B1/2−D1/2)/L1 can better reflect the transmission characteristics of the light of the marginal field of view.

In one embodiment, the field of view of the optical module is in a range of 80°≤FOV≤120°.

In the present embodiment, the field of view of the optical module is in a range of 80°≤FOV≤120°, and the optical module is applied in VR devices featuring a large field of view. For example, the field of view FOV of the optical module is 100°.

In one embodiment, the optical module satisfies: 14 mm<F<38.5 mm, wherein F is the effective focal length of the optical module.

Specifically, the optical module is applied in VR design, which actually serves to magnify the image, i.e., to see small objects or details clearly, it is necessary to move the object closer to the eye, thereby increasing the viewing angle to form a larger real image on the retina. However, when the object is too close to the eye, it is impossible to see the object clearly, so it is important not only to have a large enough angle of the image relative to the human eye, but also to choose an appropriate distance.

Specifically, the viewing angle magnification β=1+250/F serves as a parameter to measure the magnification capability of the VR system, and the present embodiment limits the range of the effective focal length of the optical module, thereby enhancing image clarity while controlling the image brightness of the marginal field of view.

For example, the optical module satisfies: 15 mm<F<30 mm.

In an optional embodiment, the size of the display screen 1 is in a range: 20 mm≤D1≤60 mm.

In the present embodiment, by limiting the size range of the display screen 1, on one hand, it is possible to ensure the range of (B1/2−D1/2)/L1 to fall within −0.2 to 0.8, thereby reducing the difference in light brightness between the marginal field of view and the central field of view; on the other hand, it is possible to make the VR device suitable for both small size display screens 1 and large size display screens 1.

In an optional embodiment, the field of view of the optical module is in a range: 80°≤FOV≤120°, the optical module satisfies: 14 mm<F<38.5 mm, and the size of the display screen 1 is in a range: 20 mm≤D1≤60 mm. In the present embodiment, the present embodiment limits the ranges of the field of view of the optical module and the size of the display screen 1, so that under the condition of increasing the field of view, the VR device can accommodate small size display screens 1, medium size display screens 1, and large size display screens 1.

In the present embodiment, in actual use, it is possible to limit the field of view FOV of the optical module to a preset angle, for example, the field of view FOV of the optical module is 100°. By balancing the relationship between the effective diameter of the polarizing element and the size D1 of the display screen 1, such as a larger effective diameter of the polarizing element corresponding to a larger size of the display screen 1, and a smaller effective diameter of the polarizing element corresponding to a smaller size of the display screen 1, it is possible to ensure that (B1/2−D1/2)/L1 satisfying the range of −0.2 to 0.8 reduces the difference in light brightness between the marginal field of view and the central field of view.

In the present embodiment, by limiting the effective focal length of the optical module, it is possible that different sizes D1 of the display screen 1 are matched with different FOVs, for example, a smaller size of the display screen 1 can be matched with a smaller FOV, or a larger size of the display screen 1 can be matched with a larger FOV, Or the large FOV can be matched with a small size screen, a medium size screen or a large size screen, thereby improving the experience effect of the user.

According to a second aspect of an embodiment of the present disclosure, a head mounted display is provided. The head mounted display includes: a housing; and the optical module as described above.

The head mounted display is, for example, a VR headset, including VR glasses or a VR helmet, which is not specifically limited in the embodiment of the present disclosure.

The specific implementation of the head mounted display in the embodiment of the present disclosure may refer to the above embodiments of the display module, and is not repeated herein.

The optical module provided by the embodiment of the present disclosure is specifically described below through three embodiments.

### First Embodiment

Referring to FIG. 1, the optical module provided by the embodiment of the present disclosure includes a display screen 1, a first lens 21 and a stop 4, wherein the first lens 21 has a second surface facing towards the display screen 1 and a first surface facing away from the display screen 1, a beam splitting element 5 is provided on the second surface, and a polarizing element 3 and a first phase retarder 6 are provided on the first surface. Here, the first phase retard 6 is provided closer to the first lens 21 with respect to the polarizing element 3.

Here, the effective diameter B1 of the polarizing element 3 is 48.57 mm (because the polarizing element 3 is provided on the surface of the first lens 21, the effective diameter herein also means that the effective diameter of the first lens 21 is 48.57 mm), the dimension D1 of the display screen 1 is 60 mm, and the distance L1 from the polarizing element 3 to the display screen 1 is 34.784 mm. Here, the effective focal length F of the optical module is 37 mm, and the FOV magnification β of the optical module is 7.76.

Here, the optical parameters of the display screen 1, the first lens 21, and the stop 4 are shown in Table 1.

| | | Curvature | Thick- | | |
|---|---|---|---|---|---|
| | | radius | ness | Refractive | Diameter |
| Type | Part | (mm) | (mm) | index (Nd) | (mm) |
| stop | Stop | Infinity | 15 | | 4 |
| first lens | P1S1 | Infinity | 6.3712 | 1.5447 | 48.57 |
| | P1S2 | −130.6907 | 28.4128 | 1.5447 | 48.57 |
| display | Display | Infinity | | | 60 |
| screen | | | | | |

The present embodiment is adapted to the size of an image surface of FOV of 100° and 60 mm (large size screen), and the incidence angle of the light of the marginal field of view is 13°. In the present embodiment, (B1/2−D1/2)/L1=−0.164, and then the display brightness of the marginal field of view is controlled to decrease by no more than 20% compared to the brightness at a 0° angle (central field of view). That is, the brightness of light in the marginal field of view has been reduced, thereby enhancing the uniformity of brightness of the display screen 1.

In addition, it should be noted that the optical module can be adapted to a small size screen, a medium size screen, and a large size screen by adjusting the parameter relationship among B1, D1, and L1.

### Second Embodiment

Referring to FIG. 2, the optical module provided by the embodiment of the present disclosure includes a display screen 1, a first lens 21, a second lens 22, and a stop 4. Here, the first lens 21 is provided farther away from the display screen 1 than the second lens 22, the first lens 21 has a first surface facing away from the display screen 1, and a second surface provided adjacent to the second lens 22, the second lens 22 has a first surface provided adjacent to the first lens 21 and a second surface facing towards the display screen 1. For example, a polarizing element 3 and a first phase retarder 6 are provided on the second surface of the first lens 21. Here, the first phase retarder 6 is provided farther away from the first lens 21 than polarizing element 3. The beam splitting element 5 is provided on the second surface of the second lens 22.

Here, the effective diameter B1 of the polarizing element 3 is 54.4 mm (because the polarizing element 3 is provided on the surface of the first lens 21, the effective diameter herein also means that the effective diameter of the first lens 21 is 54.4 mm), the dimension D1 of the display screen 1 is 56 mm (large size screen), and the distance L1 from the polarizing element 3 to the display screen 1 is 32.83 mm. Here, the effective focal length F of the optical module is 35.79 mm, and the FOV magnification β of the optical module is 7.98.

Here, the optical parameters of the display screen 1, the first lens 21, the second lens 22, and the stop 4 are shown in Table 2.

| | | Curvature | Thick- | | |
|---|---|---|---|---|---|
| | | radius | ness | Refractive | Diameter |
| Type | Part | (mm) | (mm) | index (Nd) | (mm ) |
| stop | Stop | Infinity | 15 | | 4 |
| first lens | P1S1 | 280 | 3 | 1.5447 | 54.4 |
| | P1S2 | Infinity | 1 | 1.5447 | 54.4 |
| second lens | P2S1 | 200 | 6.83 | 1.5447 | 55.7 |
| | P2S2 | −183.17 | 25 | 1.5447 | 55.7 |
| display | Display | Infinity | | | 56 |
| screen | | | | | |

The present embodiment is adapted to the size of an image surface of FOV of 100° and 56 mm (large size screen), and the incidence angle of the light of the marginal field of view is 3.6°. In the present embodiment, (B1/2−D1/2)/L1=−0.02, and then the display brightness of the marginal field of view is controlled to decrease by no more than 15% compared to the brightness at a 0° angle (central field of view). That is, the brightness of light in the marginal field of view has been reduced, thereby enhancing the uniformity of brightness of the display screen 1.

### Third Embodiment

Referring to FIG. 3, the optical module provided by the embodiment of the present disclosure includes a display screen 1, a first lens 21, a second lens 22, and a stop 4. Here, the first lens 21 is provided farther away from the display screen 1 than the second lens 22, the first lens 21 has a first surface facing away from the display screen 1, and a second surface provided adjacent to the second lens 22, the second lens 22 has a first surface provided adjacent to the first lens 21 and a second surface provided facing towards the display screen 1. For example, a polarizing element 3 and a first phase retarder 6 are provided on the second surface of the first lens 21. Here, the first phase retarder 6 is provided farther away from the first lens 21 than the polarizing element 3. The beam splitting element 5 is provided on the second surface of the second lens 22.

Here, the effective diameter B1 of the polarizing element 3 is 31 mm (because the polarizing element 3 is provided on the surface of the first lens 21, the effective diameter herein also means that the effective diameter of the first lens 21 is 31 mm), the dimension D1 of the display screen 1 is 20.7 mm (small size screen), and the distance L1 from the polarizing element 3 to the display screen 1 is 10.2 mm. Here, the effective focal length F of the optical module is 14.4 mm, and the FOV magnification β of the optical module is 18.36.

Here, the optical parameters of the display screen 1, the first lens 21, the second lens 22, and the stop 4 are shown Table 3.

| | | Curvature | Thick- | | |
|---|---|---|---|---|---|
| | | radius | ness | Refractive | Diameter |
| Type | Part | (mm) | (mm ) | index (Nd) | (mm) |
| stop | Stop | Infinity | 12 | | 4 |
| first lens | P1S1 | Infinity | 3.89 | 1.535 | 31 |
| | P1S2 | −39.12 | 0.5 | 1.535 | 31 |
| second lens | P2S1 | −67.5 | 5.5 | 1.5447 | 34.1 |
| | P2S2 | −31.236 | 4.2 | 1.5447 | 34.1 |
| display | Display | Infinity | | | 20.7 |
| screen | | | | | |

The present embodiment is adapted to the size of an image surface of FOV of 90° and 20.7 mm (small size screen), and the incidence angle of the light of the marginal field of view is −21.7°. In the present embodiment, (B1/2−D1/2)/L1=0.5, and then the display brightness of the marginal field of view is controlled to decrease by no more than 30% compared to the brightness at a 0° angle (central field of view). That is, the brightness of light in the marginal field of view has been reduced, thereby enhancing the uniformity of brightness of the display screen 1.

According to another aspect of an embodiment of the present disclosure, there is also provided a head mounted display including a housing and the optical module as described above.

The above embodiments focus on the differences between the various embodiments, and the different optimization features between the various embodiments, as long as they do not contradict each other, may be combined to form a better embodiment, which will not be repeated herein considering the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
a display screen with a size of D1, comprising a light-emitting side,
a lens group located on the light-emitting side of the display screen,
wherein the lens group comprises at least a first lens,
a polarizing element,
a beam splitting element, and
a phase retarder,
wherein the polarizing element has an effective diameter of B1; the polarizing element, the beam splitting element, and the phase retarder are provided on either one or more of a first side of the first lens facing away from the display screen and a second side of the first at least one lens facing towards the display screen;
a distance from the polarizing element to the display screen is L1;
wherein a ratio of (B1/2−D1)/L1 satisfies: −0.2<(B1/2−D1/2)/L1<0.8.

2. The optical module according to claim 1, wherein the ratio of (B1/2−D1//L1 satisfies: −0.05<(B1/2−D1/2)/L1<0.8.

3. The optical module according to claim 1, wherein the optical module has a field-of-view magnification β, which satisfies: 7.5<β<19.

4. The optical module according to claim 1, wherein the lens group further comprises a second lens adjacent to the display screen, the second lens has a surface facing towards the display screen, and the beam splitting element is located on one side of the surface of the second lens.

5. The optical module according to claim 1, wherein the polarizing element is provided on the first side of the at least one lens group facing away from the display screen; or
the lens group comprises at least two lenses, which comprise a second lens proximate to an eye side, wherein the second lens has a surface facing away from a human eye, and the polarizing element is located on one side of the surface facing away from the human eye.

6. The optical module according to claim 1, wherein the phase retarder comprises a first phase retarder, which is provided on the first side of the at least one lens facing away from the display screen, and is provided closer to the display screen than to the polarizing element; or
the lens group comprises at least two lenses, which comprise a second lens closest to an eye side, wherein the second lens has a surface facing away from a human eye, and the first phase retarder is located on one side of the surface and is provided farther away from the second lens than from the polarizing element.

7. The optical module according to claim 1, wherein the phase retarder comprises a second phase retarder, the lens group further comprises a second lens adjacent to the display screen, the second lens has a surface facing towards the display screen, and the second phase retarder is located on one side of the surface and is provided closer to the display screen than to the beam splitting element.

8. The optical module according to claim 1, wherein the lens group further comprises a second lens adjacent to the display screen, and the second lens has a positive optical power.

9. The optical module according to claim 1, wherein L1 satisfies: 10 mm<L1<35 mm.

10. The optical module according to claim 1, wherein B1 satisfies: 30 mm<B1<55 mm.

11. The optical module according to claim 1, wherein the optical module has a field of view from 80° to 120°.

12. The optical module according to claim 1, wherein the optical module has an effective focal length F, which satisfies: 14 mm<F<38.5 mm.

13. A head mounted display, comprising:
a housing; and
an optical module according to claim 1.
